(19) United States
(12) Patent Application Publication
(10) Pub. No.: US 2009/0202694 A1
(43) Pub. Date: Aug. 13, 2009

(54) APPARATUS AND METHOD FOR SLICING VEGETABLES

(75) Inventors: John C. Julian, Richland, WA (US); Christopher M. Smith, Richland, WA (US)

Correspondence Address: KLARQUIST SPARKMAN, LLP, 121 SW SALMON STREET, SUITE 1600, PORTLAND, OR, 97204, US

(73) Assignee: ConAgra Foods Lamb Weston, Inc.

(21) Appl. No.: 12/367,327

(22) Filed: Feb. 6, 2009

Related U.S. Application Data
(60) Provisional application No. 61/065,107, filed on Feb. 8, 2008.

(51) Int. Cl. A47J 43/00; B26D 7/06; B26D 1/12; A23P 1/10

(52) U.S. Cl. 426/506; 99/537; 83/403; 83/663; 426/518

(57) ABSTRACT

A cutting apparatus for slicing potatoes includes an impeller hub block, impeller tubes radially extending from the impeller hub block, and a cutting assembly circumferentially surrounding at least a portion of the impeller hub block. The impeller hub block includes a potato holding area and an opening for receiving potatoes into the holding area. The impeller tubes have an entry aperture and an exit aperture, and a longitudinal length greater than about 5 inches. The impeller hub block is rotatable about a central vertical axis and each impeller tube is rotatable about its own longitudinal axis.

### FIELD

The present invention relates generally to food processing, and more particularly to a unique vegetable product and process for making the same.

### BACKGROUND

Deep-fried (“french-fried”) potato products are produced in many shapes and sizes, including rectangular or square julienne-type strips, slices, wedge cuts, helical spirals, and waffle cuts. Such products typically are processed by cutting whole potatoes into the desired shape, and then blanching, parfrying, and freezing the cut pieces. When reconstituted by oil frying, such products characteristically have an oil content of about 10-20% and a solids content of about 40-65% (including oils) by weight.

Waffle cut fries, in particular, are produced by cross-cutting a potato chip at two different angles, generally 90 degrees apart, and with a corrugated pattern. This type of cut produces a potato chip with longitudinal ridges and grooves formed in both cut surfaces. Waffle cut fries are currently commercially produced by the methods and machinery described in U.S. Pat. Nos. 4,523,503 and 4,949,612, the disclosures of which are hereby incorporated by reference. The cutting machines of U.S. Pat. Nos. 4,523,503 and 4,949,612 are modified and improved versions of previous cutting machines disclosed in U.S. Pat. Nos. 3,139,137 and 3,139,130, which are directed to producing thin, potato chip-type products. The disclosures of U.S. Pat. Nos. 3,139,137 and 3,139,130 are also incorporated by reference herein.

Each of U.S. Pat. Nos. 4,523,503 and 4,949,612 discloses a food slicing machine with a carriage and a stationary cutting assembly surrounding the carriage. The stationary cutting assembly has four circumferentially-spaced knife assemblies positioned 90 degrees apart from one another. Potatoes are fed into a central opening at the top of the carriage and the carriage is rotated. The centrifugal force resulting from the rotation of the carriage directs the potatoes into one of four guide tubes that extend radially from the carriage. Longitudinal ribs in the guide tubes hold the potatoes in place while the carriage rotates, causing the potatoes to be cut by the stationary cutting assembly surrounding the carriage. In addition, to achieve the waffle cut, each guide tube also rotates about its own axis. Ideally, in the time it takes the carriage to rotate the 90 degrees from one knife assembly to the next, each guide tube also rotates 90 degrees so that each sliced section has ridges and grooves on one side that are disposed perpendicularly to ridges and grooves on the other side.

The current methods and machinery for producing waffle cut fries, however, have several shortcomings. First, they produce a relatively high amount of waste. In addition to scrap, the current machines produce product that, though acceptable for some purposes, is not cross-cut at the desired 90 degree angle and therefore does not meet the desired quality standard. Accordingly, it is desirable to improve the efficiency of the process in order to decrease the amount of waste.

Waste and quality control issues are exacerbated by problems relating to off-axis feeding of potatoes into the impeller tubes. Off-axis alignment during feeding creates waffle fries of less desirable oblong shapes, thereby decreasing the desired output consistency and increasing waste. Moreover, off-axis alignment can cause additional production problems by contributing to plugging or clogging of the guide tubes, which can force production shutdowns further reducing manufacturing efficiency.

Accordingly, there is a need for new and improved apparatus and methods for manufacturing high quality waffle cut fries.

### SUMMARY

In one embodiment, a cutting apparatus for slicing vegetables, such as potatoes, is provided. The apparatus comprises an impeller hub block, a plurality of impeller tubes, and a cutting assembly. The impeller hub block includes a potato (vegetable) holding area and an opening for receiving potatoes (vegetables) into the holding area. A plurality of impeller tubes can radially extend from the impeller hub block and can have a longitudinal length of greater than about 5 inches. More preferably, the length of the impeller tubes can be between about 5 and 15 inches. The impeller tubes can have an entry aperture and an exit aperture. The cutting assembly can circumferentially surround at least a portion of the impeller hub block. The impeller tubes are rotatable about a central vertical axis of the impeller hub block and each impeller tube is rotatable about its own longitudinal axis.

In certain specific embodiments, the impeller tubes can have a longitudinal length of between about 5 and 15 inches, and more preferably between about 7 and 10 inches. In other specific embodiments, the cutting assembly comprises a blade holding member and a blade. The blade can include a corrugated edge with groove and ridge portions on both sides of the blade and can form an angle with a tangent of the inner diameter of the cutting assembly that is less than about 15 degrees. More preferably, the angle formed by the blade and the tangent of the inner diameter of the cutting assembly can be about 10 degrees or less.

In other specific embodiments, the holding area can comprise a substantially flat base portion or a base portion having a plurality of ridges that extends upward toward the opening. The holding area can also comprise a base portion that has a projection that extends upward toward the opening. The projection can have a plurality of side surface portions with each side surface portion directed generally outwards towards one of the entry apertures of the impeller tubes. In other specific embodiments, at least a portion of an internal surface of each impeller tube can comprise a rough surface.

In other specific embodiments, the cutting assembly can comprise a blade holding member and a blade. The blade can include a corrugated cutting edge with groove and ridge portions on both sides of the blade. The blade holding member can be a one-piece injection molded part that surrounds and holds the blade. The blade holding member can comprise a plurality of spaced fingers on each side of the blade and extending toward the corrugated cutting edge and contacting the groove portions on both sides of the blade.

In another embodiment, a cutting apparatus for slicing potatoes is provided. The apparatus comprises an impeller hub block, a plurality of impeller tubes, and a cutting assembly. The impeller hub block can comprise a potato holding area and an opening for receiving potatoes into the holding area. The plurality of impeller tubes can radially extend from the impeller hub block, with the impeller tubes being rotatable about a central vertical axis of the impeller hub block and each impeller tube is being rotatable about its own longitudinal axis. The impeller tubes can have an entry aperture and an exit aperture. A cutting assembly can circumferentially surround at least a portion of the plurality of impeller tubes. Preferably, the cutting assembly comprises an inner surface with a radius of curvature that is greater than about 7.5 inches.

In specific embodiments, the radius of curvature of the inner surface of the cutting assembly is greater than about 9 inches. In other specific embodiments, each impeller tube can have a longitudinal length of between 5 and 10 inches. In other specific embodiments, the cutting assembly can comprise four knife assemblies, with each knife assembly spaced apart about 90 degrees from one another.

In other specific embodiments, each knife assembly can comprise a blade holding member and a blade, with the blade including a corrugated edge with groove and ridge portions on both sides of the blade. The blade can form an angle with a tangent of the inner diameter of the cutting assembly that is less than about 15 degrees. More preferably, the angle formed by the blade and the tangent of the inner diameter of the cutting assembly can be about 10 degrees or less. In other specific embodiments, the cutting assembly can comprise a plurality of knife assemblies that is less than the number of impeller tubes.

A method for slicing potatoes is also provided. The method comprises providing an impeller hub block coupled to a plurality of impeller tubes that radially extend from the impeller hub block. A cutting assembly circumferentially surrounding at least a portion of the plurality of impeller tubes is provided. A plurality of potatoes that have a length greater than about three inches are provided. The plurality of potatoes are fed into an opening in the impeller hub block. The impeller hub block rotates about a central vertical axis, causing a first potato and a second potato to be received in one of the impeller tubes in an end-to-end configuration. An outside portion of the first potato is cut with the first potato being at a first orientation. The impeller tube rotates about its own longitudinal axis to cause the first potato to be at a second orientation. The first potato is cut at the second orientation. While the first and second potatoes are in the end-to-end configuration within the one impeller tube, at least one of the first and second potatoes is completely contained within the one impeller tube and the other of the first and second potatoes is at least partially contained in the one impeller tube.

In specific embodiments, the method further comprises pre-heating the plurality of potatoes before the potatoes are fed into the opening of the impeller hub block. In other specific embodiments, the act of feeding the plurality of potatoes comprises delivering water into the opening in the impeller hub block.

The foregoing and other objects, features, and advantages of the invention will become more apparent from the following detailed description, which proceeds with reference to the accompanying figures.

### BRIEF DESCRIPTION OF THE DRAWINGS

FIG. 1 is a perspective view of an apparatus for slicing vegetables, incorporating an impeller hub block, impeller tubes, and a cutting assembly, with the outer surface of the cutting assembly shown as transparent.

FIG. 2 is a top view of apparatus of FIG. 1.

FIG. 3 is a cross-section view taken along line 3-3 of FIG. 2.

FIG. 4 is a side view of the apparatus of FIG. 1, with the outer surface of the cutting assembly shown as transparent.

FIG. 5 is a perspective view of an apparatus for slicing vegetables, incorporating an impeller hub block, impeller tubes, and a cutting assembly, with the outer surface of the cutting assembly shown as transparent.

FIG. 6 is a cross-section view of the apparatus of FIG. 5, showing the apparatus at a cross-section taken along the midpoint of the impeller tubes.

FIG. 7 is a side, cross-section view of the apparatus of FIG. 5, taken along line 7-7 in FIG. 5.

FIG. 8 is a top view of a portion of an apparatus for slicing vegetables.

FIG. 9 is a side, cross-section view of the apparatus of FIG. 8, taken along line 9-9 in FIG. 8.

FIG.10 is a side view of the apparatus of FIG. 8.

### DETAILED DESCRIPTION

As used in this application and in the claims, the singular forms “a,” “an,” and “the” include the plural forms unless the context clearly dictates otherwise. Additionally, the term “includes” means “comprises.” Further, the terms “coupled” and “associated” generally means electrically, electromagnetically, and/or physically (e.g., mechanically or chemically) coupled or linked and does not exclude the presence of intermediate elements between the coupled or associated items.

Although the operations of exemplary embodiments of the disclosed method may be described in a particular, sequential order for convenient presentation, it should be understood that disclosed embodiments can encompass an order of operations other than the particular, sequential order disclosed. For example, operations described sequentially may in some cases be rearranged or performed concurrently. Further, descriptions and disclosures provided in association with one particular embodiment are not limited to that embodiment, and may be applied to any embodiment disclosed.

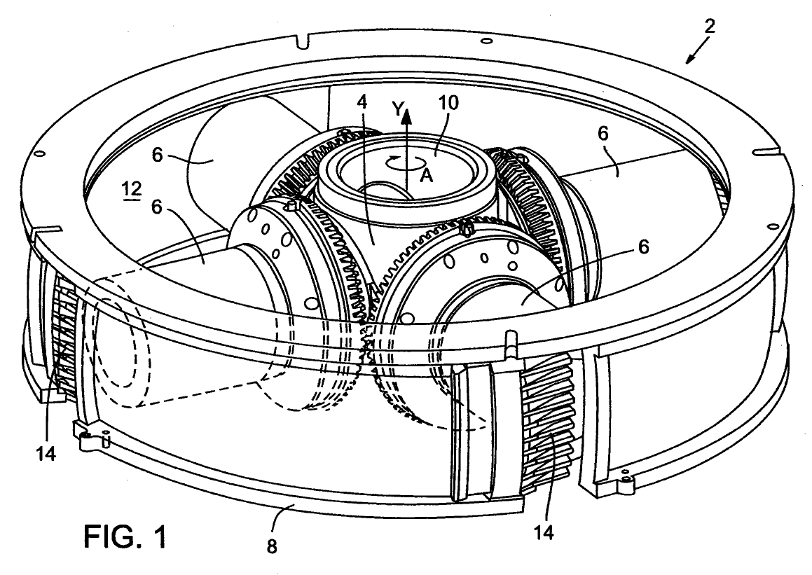

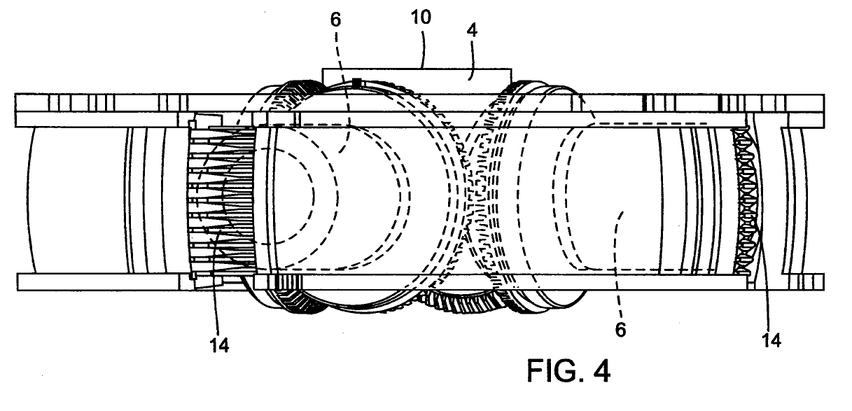

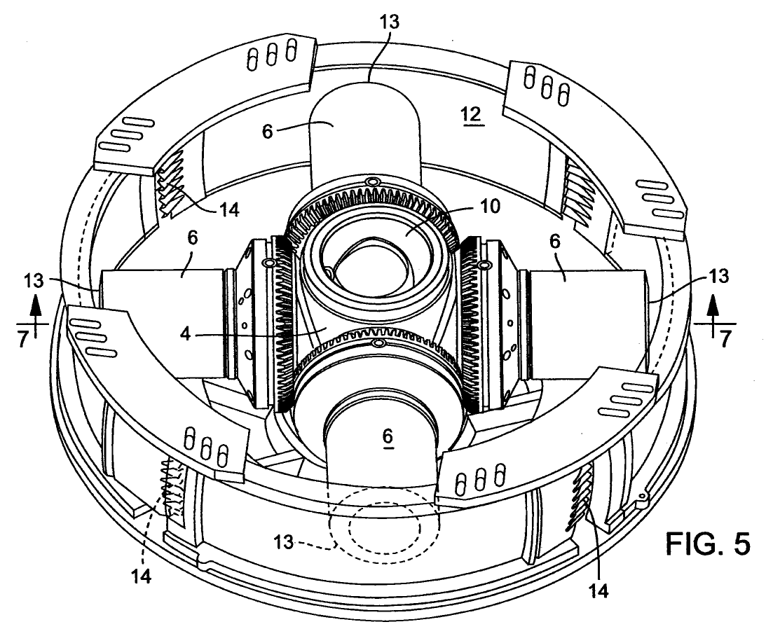

Referring to FIGS. 1-7, a cutting apparatus 2 includes an impeller hub block 4, four impeller tubes 6, and a stationary cutting assembly 8. Impeller hub block 4 has a central vertical opening 10 for receiving vegetables, such as potatoes, into a vegetable or potato holding area. Although much of the description below will describe the use of the cutting apparatus for cutting potatoes, it should be understood that other vegetables can be substituted for potatoes. Of course, depending on the size of the vegetable being cut, it may be desirable to modify one or more dimensions described below for use with potatoes.

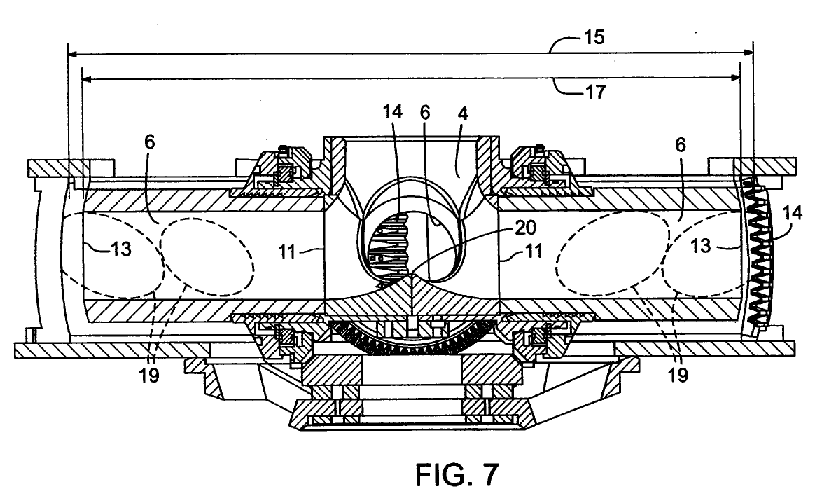

A substantially solid floor lies immediately below opening 10 and prevents the product from exiting the impeller hub block except through impeller tubes 6. The floor is attached to a vertical shaft 11 (shown in FIG. 7) which rotates impeller hub block 4 and the associated impeller tubes 6 about axis Y in the direction of A.

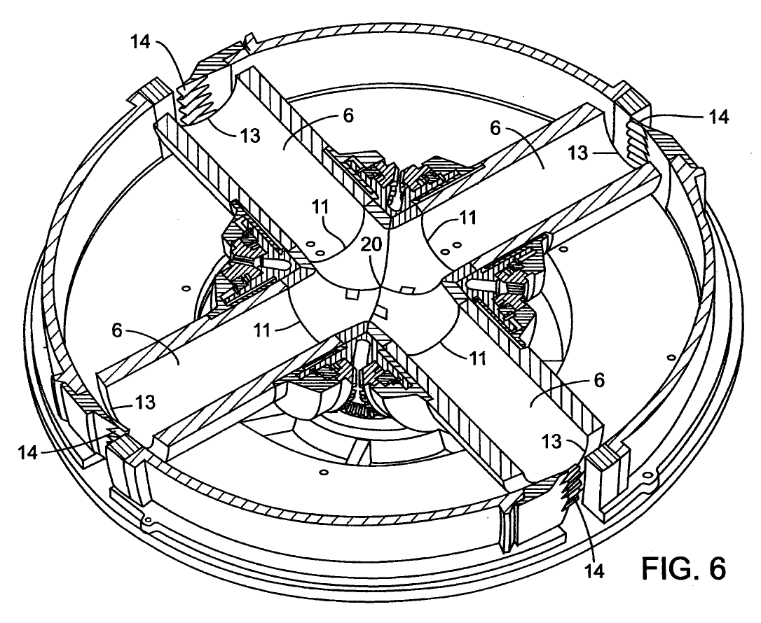

The four impeller tubes 6 are coupled to and radially extend from impeller hub block 4 and can be spaced 90 degrees apart. Impeller tubes 6 are attached to impeller hub block 4 by bearings so that each impeller tube 6 is separately rotatable around its own longitudinal axis. As best seen in FIG. 6, each impeller tube 6 has two openings: an entry aperture 11 in the vicinity of impeller hub block 4 and an exit aperture 13 in the vicinity of cutting assembly 8.

Cutting assembly 8 at least partially surrounds impeller hub block 4 and preferably has a spherically curved inner surface 12. It should be noted that the spherical curvature is not necessary for the purposes of this invention and the inner surface could be annular in shape. However, the spherically curved inner surface provides a tighter clearance between the cutting assembly and the potatoes being cut.

Cutting assembly 8 includes four sets of circumferentially spaced knife assemblies 14 positioned 90 degrees apart. Each knife assembly 14 has an inner and an outer clamping member and a corrugated knife clamped therebetween. Knife assembly 14 preferably has an overall spherical curvature that corresponds to that of inner surface 12. The knife assembly of the present invention is the same as that disclosed in U.S. Pat. No. 4,523,503, which has been incorporated by reference, except for the distinctions and differences specifically discussed below.

In operation, potatoes are fed into opening 10, whereupon they are forced outwardly by the centrifugal force resulting from the rotation of impeller hub block 4. The only exit path for the outwardly forced potatoes is through one of the impeller tubes 6. As the potatoes reach the end of impeller tube 6, they contact inner surface 12 of cutting assembly 8. In this manner, as impeller hub block 4 rotates and forces the potatoes to the outer end of the impeller tubes, each knife assembly 14 contacts a potato projecting from one of the impeller tubes 6 and slices off a substantially ellipsoidal section as the impeller tube 6 passes the knife assembly. Before each impeller tube 6 reaches the next cutting assembly, the impeller tube 6 rotates 90 degrees so that the next slice is cut perpendicular to the previous slice.

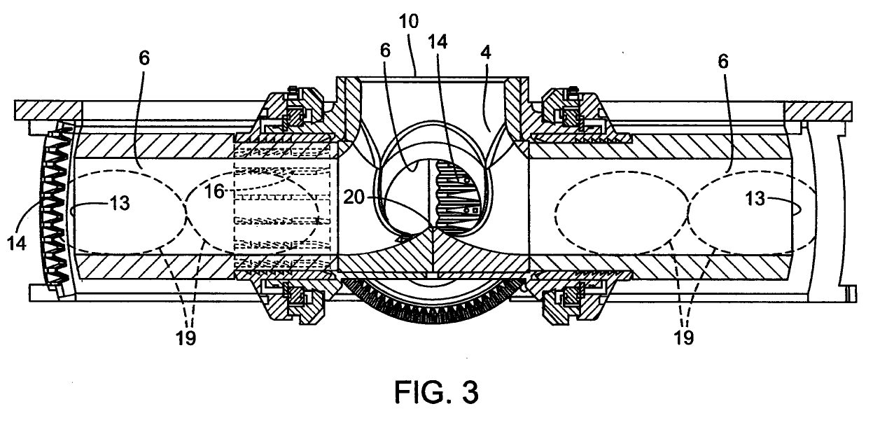

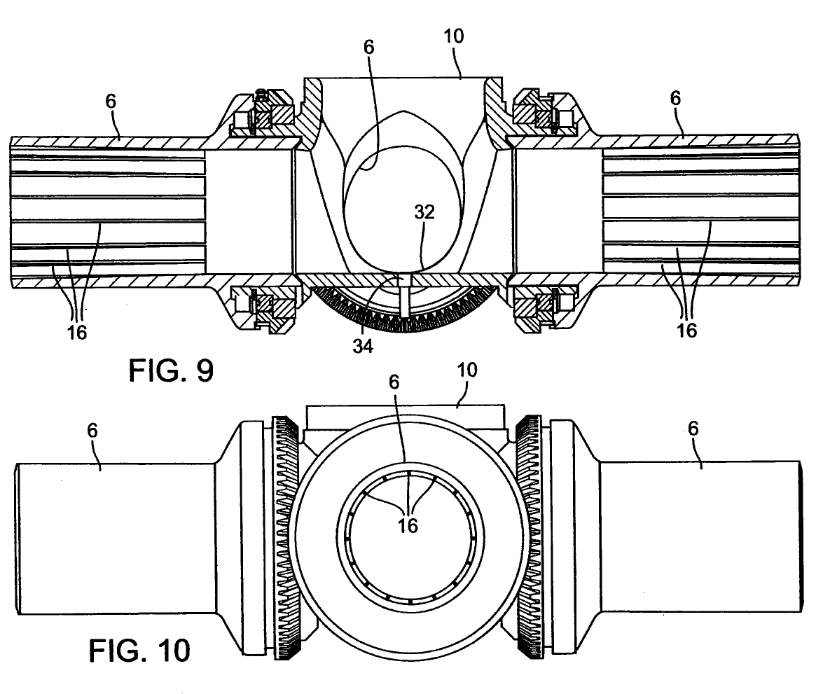

The inside surface of impeller tubes 6 can be configured to be smooth (e.g., FIG. 6) or rough (e.g., FIG. 3 and FIG. 9). In some circumstances it may be desirable to have a roughened or non-smooth surface that extends along at least a part of the length of the inside surface of the impeller tubes 6. As shown in FIG. 3, for example, longitudinal ribs 16 can extend along at least a portion of the inner surfaces of the impeller tubes 6. These ribs 16 grip or at least guide the potatoes 19 so that the potatoes 19 rotate together with the impeller tube 6, thereby encouraging the full 90 degree rotation of the potatoes between cuts. If desired, ribs 16 can be configured to extend the length of the impeller tubes. The ribs 16 shown in FIG. 3 are jagged; however, ribs 16 can be formed in any manner, including the non-jagged ribs 16 shown in FIG. 9, so long as the surface is roughened to help grip or guide the potatoes 19 through the impeller tube in the manner described herein.

Traditional cutting apparatus have impeller tubes that are shorter than the length of most potatoes that are selected to be sliced. Thus, when a potato enters the traditional cutting apparatus it is only partially contained within the tube. Such traditional cutting apparatus have impeller tubes that are about 3 inches or less in length. In a preferred embodiment of the present invention, however, the impeller tubes are significantly longer and are capable of fully containing an entire potato and, preferably, at least a portion of a second potato.

In particular, the length of impeller tube 6 associated with the impeller hub block is preferably greater than 5 inches. The upper limit for the length of impeller tubes is limited primarily by the practicalities of building a functioning apparatus. As the impeller tubes get too large, it takes a greater amount of force to rotate the hub block at a speed that is sufficient to properly cut the food product. Thus, above about 15 inches in length, the apparatus is more difficult to build and control. Accordingly, the length of the impeller tube is between about 5 and 15 inches or, even more preferably, between 7 and 10 inches. In one example of the present invention, a cutting apparatus was formed with each impeller tube being approximately 8.25 inches long. This arrangement permits the impeller tube to contain within it an entire first potato as well as a part of a second potato that is queued up behind the first. Of course, the number of potatoes that can be accommodated in any length of tubing varies depending on the length of the potato. However, as a general principle, if the potato length is small, the potato will yield fewer slices between the two end cuts. Accordingly, longer potatoes can be preferable, at least in terms of providing a greater number of quality slices between the two end cuts. A tube that is about 5 inches or greater in length can, for example, fit two potatoes having a length of about 2.5 inches within the same tube. Even if the potatoes selected for slicing are longer than 2.5 inches, the longer length tubing (e.g., greater than about 5 inches) will still provide a benefit by allowing a larger portion of a second potato into the tube than is possible with traditional length impeller tubes. Referring to FIGS. 3 and 7, for example, two potatoes 19 are shown within a single impeller tube. The potatoes 19 in both illustrated embodiments (FIGS. 3 and 7) are in an end-to-end configuration within the one impeller tube and at least the second (non-leading) potato is completely contained within the one impeller tube while the first (leading) potato is at least partially contained in the one impeller tube. Preferably, the potatoes 19 are greater than about three inches in length.

By lengthening impeller tubes 6 as described above, it is possible to achieve better alignment of a potato by the time it reaches the end of the impeller tube. In particular, the longer travel distance inside the impeller tube increases the chances that the potato will stabilize and settle with the proper longitudinal alignment. With improved potato alignment, it is possible to achieve more consistent and higher quality waffle cut slices. In addition, a longer tube provides sufficient space so that more than one potato can occupy the tube at a time. The additional, queued-up potatoes further stabilize the potatoes at the cutting stage by physically contacting the potatoes and exerting physical pressure on them, thereby keeping them firmly pressed up against the cutting assembly. Moreover, by queuing up additional potatoes, it is possible to improved feeding efficiency because there will always be a second potato in position to be cut as soon as the prior potato fully exits the impeller tube. Finally, by lengthening the impeller tube as discussed above, the centrifugal force exerted on the potatoes urging them against cutting assembly 8 is increased. This increase in force against the cutting assembly further contributes to more consistent, high quality waffle cut slices.

The use of longer impeller tubes has several additional benefits. Longer impeller tubes increase the diameter of cutting assembly 8. Referring to FIG. 7, for example, as the impeller tubes are lengthened, the inner diameter 15 of the cutting assembly 8 also increases. Since cutting assembly 8 preferably has a spherical shape, an increase in the inner diameter 15 of cutting assembly 8 results in a flatter inner surface 12. Because knife assembly 14 preferably has a curvature that corresponds to that of inner surface 12, a flatter inner surface 12 also provides a flatter curvature for knife assemblies 14. A flatter curvature of the knife assembly results in a more consistent and better quality slice because the potato can be held closer to inner surface 12.

The inner diameter 15 of cutting assembly 8 is preferably greater than about 15 inches, which corresponds to a radius of curvature of greater than about 7.5 inches. At a radius of curvature of greater than about 7.5 inches, inner surface of the cutting assembly 8 is able to provide a substantially flat surface for cutting food products. More preferably, the diameter 15 of the inner surface of the cutting assembly is greater than about 18 inches (with a radius of curvature greater than about 9 inches), and more preferably greater than about 20 inches (with a radius of curvature greater than about 10 inches). In one preferred embodiment, the radius of curvature is between about 11 and 12 inches.

As seen in FIG. 7, outer diameter 17 of the impeller hub block 4, defined by the distances between opposing exit apertures 13 of impeller tubes 6 (at least when there are at least two impeller tubes diametrically aligned as in FIG. 7). As potatoes 19 exit the exit aperture 13, an outer portion of the leading potato moves along the inner surface of the cutting assembly 8 until it impacts a knife assembly 14.

The flatter curvature of the inner surface and knife assembly also permit the angle of the cutting blade of knife assembly 14 to be less steep. When using a cutting blade with a steep angle, significant force is exerted on the blade to cut the potato and force the potato slice to change direction and exit the knife assembly at the same steep angle. Thus, the use of a knife assembly with a cutting blade that has a steep angle causes significant wear and tear on the blade itself and on the knife assembly in general. The steep angle means that each slice is diverted outwardly of cutting assembly 8, through a gap formed by knife assembly 14 and cutting assembly 8, at a corresponding steep angle relative to the path of the orbiting potatoes from which the slice is taken. The sudden and significant change in direction experienced by the slice as the blade impacts the potato creates a greater risk that the slice will fracture or tear during the slicing operation. The angle of the blades used on traditional cutting machines with traditionally sized impeller tubes is about 20 degrees from the tangent of the inner surface of the cutting assembly. With the increase in impeller tube length and the related increase in cutting assembly diameter of the present invention, the angle of the blade (as measured from the tangent of the inner surface of the cutting assembly) can be less than 15 degrees, and more preferably 10 degrees or less. In a preferred embodiment, a 10 degree angle was found to be effective and, in combination with the longer impeller tubes, improved the output quality of the cutting apparatus. Accordingly, it is desirable to reduce the severity and steepness of the cutting angle of the knife assembly by using the flatter knife assembly discussed above.

The internal size of the impeller tubes 6 preferably fit the size or type of product (e.g., potato) that is to be cut. Thus, the inside diameter of each impeller tubes can vary from about 3 to 5 inches, more preferably between about 3.75 and 4 inches.

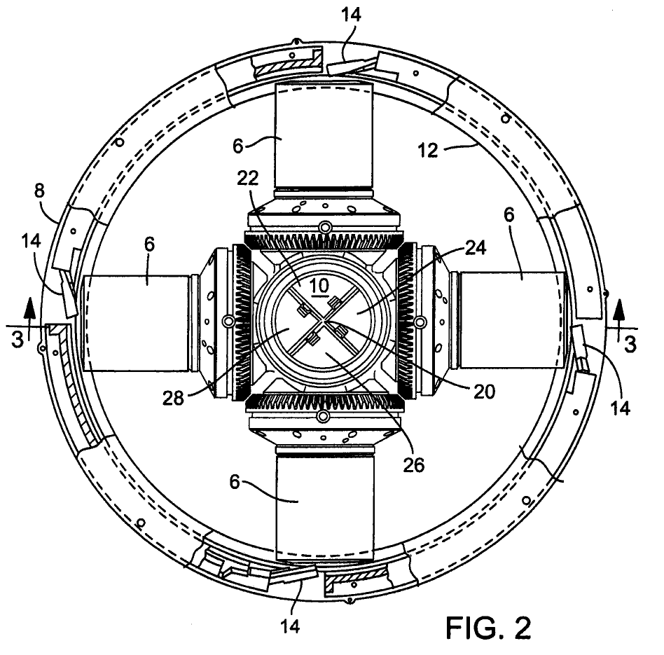

In another embodiment of the invention, the impeller hub block can have a raised projection 20 on the solid floor or base portion of impeller hub block 4. As seen in FIGS. 2, 3, 6, and 7, projection 20 can be, for example, a conical structure formed at the center of the solid floor. Referring to FIG. 2, projection 20 can assist the sorting of certain vegetables as they enter opening 10. Projection 20 preferably has four side surfaces that are either physically distinct (such as a pyramidal shape) or physically non-distinct (such as a conical shape). If the side surfaces are continuous and non-distinct, side surface portions can be defined by dividing the structure into quadrants established by the location of the impeller tubes. For example, FIG. 2 discloses a cone projection with four non-distinct side surface portions. For the purpose of defining the four side surface portions of the conical shape, projection 20 can be considered to be divided into the four side surface portions 22, 24, 26, 28 shown in FIG. 2 when looking down into opening 10.

Projection 20 effectively creates several paths of travel for the vegetables to be sliced. Each of the four side surface portions generally face and/or extend outward (and downward) towards an entry aperture that leads into an impeller tube. The sloping surface may be gradual and smooth, or disconnected and abrupt. The four side surface portions operate to generally direct a potato towards a respective facing impeller tube. That is, when a vegetable is dropped into opening 10, it lands on one of the four side surface portions of projection 20 and is directed toward the entry aperture of the impeller tube that is facing that particular side surface portion. By pre-sorting vegetables in this manner, it is possible to reduce the amount of plugging or clogging of the cutting machine and realize a smoother operating cutting machine with a higher feeding rate. Also, when vegetables strike projection 20, their paths can be altered and the vegetables can be realigned into the proper orientation desired for entry into an impeller tube.

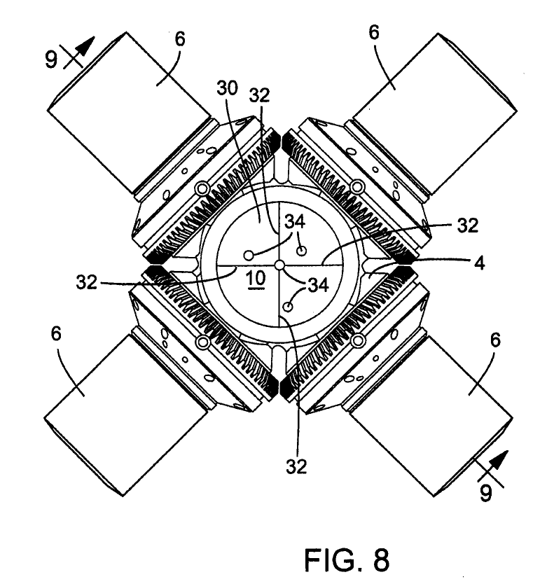

As discussed above, projection 20 is optional. For some products, such as potatoes, the projection can create an obstruction that actually slows the cutting operation. Accordingly, FIG. 8 illustrates impeller block hub 4 without a projection 20. Instead, floor or base portion 30 is substantially flat or contains slight ridges 32 where the adjacent rounded surfaces that lead to impeller tubes 6 meet one another. In particular, the floor 30 can comprise a plurality of curved surfaces that comprise at least part of the curvature of two intersecting tubes.

The potatoes can be fed into the impeller block hub 4 in a variety of ways. As potatoes, or other vegetables, enter opening 10 and strike or contact the floor 30, the rotational force of the hub 4 causes the potatoes to move towards one of the impeller tubes 6. This is true whether the floor 30 is flat or contains slight ridges 32 (as shown in FIG. 8). Slight ridges 32, however, can help to direct the potatoes towards one of the entry aperture of the impeller tube, as the ridges 32 will tend to cause the potatoes to move towards one or another of the impeller tubes 6 since the potatoes will not simply lie flat in a center portion of the floor 30. One or more holes 34 can be formed in the floor 30 to facilitate the draining of any fluids that may be used to either clean the cutting apparatus or to improve the feeding of potatoes into the impeller tubes, as discussed above.

In yet another embodiment, a feeding tube can be used to help direct and feed potatoes into the impeller tubes. The feeding tube can be J-shaped and disposed above the opening in the top of the impeller hub block. The feeding tube can be configured such that it is rotatable about a vertical axis so that the lower end of the tube can rotate and track the entry apertures of each of the impeller tubes. In one embodiment, potatoes are fed into a first (top) opening of the feeding tube. A second (bottom) opening of the rotating feeding tube lines up with one of the entry apertures of a first impeller tube. After a potato is fed into the entry aperture of the first impeller tube, the second opening of the feeding tube rotates so that the second opening is directed toward the entry aperture of a second impeller tube. A second potato is then fed into the second impeller tube. The rotation of the feeding tube is preferably at a different speed than the rotation of the impeller block hub.

The rotation of the feeding tube is preferably slower than that of the impeller hub itself, so that the second opening of the feeding tube effectively moves from one impeller tube to the next. Alternatively, the rotation of the feeding tube preferably varies, so that it pauses at the entry aperture of one impeller tube before changing speed and moving on to the next one.

In yet another embodiment, the present invention improves upon the knife assembly structure disclosed in U.S. Pat. No. 4,523,503, which has been incorporated by reference. U.S. Pat. No. 4,523,503 discloses a knife assembly with inner and outer clamping members and a corrugated knife secured therebetween. The clamping members are metal and secured together by convention means, such as screws, bolts, etc. The use of conventional methods for securing the clamping members, however, has several drawbacks.

First, these methods require adjustment to ensure proper alignment of the knife assembly. Each time the blade or clamping members must be replaced, time and effort is required to adjust and tune the knife assembly so that it is in the proper position. In addition, the screws, bolts, and other securing members can come loose over time and the knife assembly can become misaligned during operation. Accordingly, there is a need for an improved blade holding member that does not require significant alignment and adjustment during installation and use.

This embodiment of the present invention solves the above problems by forming the inner and outer clamping members as a single integral unit. This single piece blade holder is preferably injection molded and has the same general shape and structure of the inner and outer clamping members of U.S. Pat. No. 4,523,503 when those parts are secured together about the blade. The one piece injection molded part preferably includes a slot for receiving the corrugated blade. Of course, additional, conventional means for securing the blade to the blade holder may be employed if necessary to further secure the blade to the injection molded blade holder.

The blade includes a corrugated cutting edge with groove and ridge portions on both sides of the blade. The one-piece injection molded part surrounds and holds the blade in place. To support the knife and to facilitate the cutting process, the blade holding member also includes a plurality of spaced fingers on each side of the blade. These fingers extend toward the corrugated cutting edge and contact the groove portions on both sides of the blade.

Because of the accuracy of tolerances of injection molded parts, it is possible to produce a blade holder that requires little or no adjustment when the blade holder is attached to the cutting assembly. By eliminating adjustment time and effort, the machinery of the present invention can be operated with greater efficiency.

In yet another embodiment, the present invention provides an apparatus with an improved cutting assembly. Current cutting assemblies utilize four separate knife assemblies spaced 90 degrees apart. When this structure is combined with an impeller hub block that has four impeller tubes also spaced 90 degrees apart, the end result is that each knife assembly is slicing a potato at the same time. Thus, the cutting apparatus must absorb the force of four cutting impacts at once. The present invention reduces this four-point impact force by providing an apparatus with fewer knife assemblies than impeller tubes. In this way, the cutting operation of the knife assemblies can be smoother since there is only the force of one knife assembly cutting a potato at a time. Alternatively, the fewer knife assemblies can be spaced so that two or more knife assemblies are cutting a potato at one time; however since there are fewer than four knife assemblies cutting at any one time, the cumulative cutting force at any given moment is still reduced.

In a preferred embodiment, there can be three knife assemblies spaced 120 degrees apart. Because there is one fewer knife assembly, the rotation of the impeller tubes about their longitudinal axis could be slowed down to account for the one less knife assembly and still provide for a 90 degree rotation between each slice of a potato. Alternatively, it would be possible to speed up the rotation of the cutting assembly, rather than decrease the rotation of the impeller tubes, in order to provide for the 90 degree rotation of the potatoes between slices. When providing a system with fewer knife assemblies than impeller tubes, the system can have one less knife assembly than impeller tubes (as discussed above) or, alternatively, it can have two or more fewer knife assemblies.

Furthermore, it may be preferable to increase the number of impeller tubes rather than decrease the number of knife assemblies. An increase in impeller tubes can increase the rate that potatoes can be fed into the potato holding area by providing additional tubes into which the potatoes can enter. For example, the cutting apparatus could be modified to have additional impeller tubes by either increasing the interior impeller hub block diameter, decreasing the size of the bearings of the impeller tubes, or a combination of both of these approaches. The spacing of the impeller tubes should be even, such that the impeller tubes are spaced 360/x degrees apart, where x is the number of impeller tubes. Theoretically, there is no limit to the number of impeller tubes that can be formed; however, because of the practicalities associated with increasing the size of the cutting apparatus itself, in this embodiment it is preferable to have between 5 and 8 impeller tubes.

The cutting apparatus formed by increasing the number of impeller tubes can also be formed with an identical number of impeller tubes and knife assemblies. In this manner, it would operate much as the embodiment disclosed above with four impeller tube and four knife assemblies. Of course, when more than four impeller tubes and knife assemblies are used, the spacing between these elements would change. For a system with the same number of impeller tubes and knife assemblies, the spacing between each would be 360/n degrees, where n is the number of either impeller tubes or knife assemblies.

If desirable, the product that is to be sliced or cut can be pre-heated to improve the quality of the finished cut product. For example, when slicing potatoes with the cutting apparatus, pre-heating can reduce slice cracking or fracturing as well as reduce the likelihood of damage to the cutting tool. The potatoes (or other product to be sliced) can be heated in a bath of about 130 degrees F. until the core temperature of the potatoes is greater than about 100 degrees F., and more preferably between about 110-120 degrees F. Moreover, it may be preferable to slice potatoes with the machine shortly after the potatoes undergo the pre-heating process. Thus, it is desirable that the time from pre-heating to cutting be less than about 40 minutes, and more preferably, less than about 30 minutes, and even more preferably less than 5 minutes. To facilitate movement of the potatoes through the cutting apparatus, it may be desirable to spray or direct water (or other similar mediums) into the in-feed area.

The rotational speed of the impeller hub block can vary. Obviously, higher speeds can provide higher throughput and, at least for that reason are more desirable. However, high speeds can also result in increases in plugging or other cutting malfunctions, such as slice cracking or fracturing. Preferably the rotational speed of the impeller hub block ranges between 100 and 400 rpm. The optimal rotational speed of the impeller hub block will vary depending on the specific type of product being cut. For example, the optimal rotational speed will vary for different types of potatoes. In addition, the optimal rotational speed can vary based on other factors, such as the amount and timing of any pre-heating that may be employed.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A cutting apparatus for slicing potatoes comprising:
an impeller hub block, the impeller hub block comprising a potato holding area and an opening for receiving potatoes into the holding area;
a plurality of impeller tubes radially extending from the impeller hub block and having a longitudinal length of between about 5 and 15 inches, the impeller tubes having an entry aperture and an exit aperture; and
a cutting assembly, the cutting assembly circumferentially surrounding at least a portion of the impeller hub block;
wherein the plurality of impeller tubes are rotatable about a central vertical axis of the impeller hub block and each impeller tube is rotatable about its own longitudinal axis.

2. The cutting apparatus of claim 1, wherein each impeller tube has a longitudinal length of between about 7 and 10 inches.

3. The cutting apparatus of claim 1, wherein the cutting assembly comprises a blade holding member and a blade, the blade including a corrugated edge with groove and ridge portions on both sides of the blade, the blade forming an angle with a tangent of the inner diameter of the cutting assembly that is less than about 15 degrees.

4. The cutting apparatus of claim 1, wherein the angle formed by the blade and the tangent of the inner diameter of the cutting assembly is about 10 degrees or less.

5. The cutting apparatus of claim 1, wherein the holding area comprises a substantially flat base portion.

6. The cutting apparatus of claim 1, where the holding area comprises a base portion having a plurality of ridges that extends upward toward the opening.

7. The cutting apparatus of claim 1, wherein the holding area comprises a base portion having a projection that extends upward toward the opening, the projection having a plurality of side surface portions with each side surface portion directed generally outward towards one of the entry apertures of the impeller tubes.

8. The cutting apparatus of claim 1, wherein at least a portion of an internal surface of each impeller tube comprises a rough surface.

9. The cutting apparatus of claim 1, wherein the cutting assembly comprises a blade holding member and a blade, the blade including a corrugated cutting edge with groove and ridge portions on both sides of the blade, the blade holding member being a one-piece injection molded part that surrounds and holds the blade, the blade holding member comprising a plurality of spaced fingers on each side of the blade and extending toward the corrugated cutting edge and contacting the groove portions on both sides of the blade.

10. A cutting apparatus for slicing potatoes comprising:
an impeller hub block, the impeller hub block comprising a potato holding area and an opening for receiving potatoes into the holding area;
a plurality of impeller tubes radially extending from the impeller hub block, the impeller tubes being rotatable about a central vertical axis of the impeller hub block and each impeller tube being rotatable about its own longitudinal axis, the impeller tubes having an entry aperture and an exit aperture; and
a cutting assembly circumferentially surrounding at least a portion of the plurality of impeller tubes, the cutting assembly having an inner surface with a radius of curvature that is greater than about 7.5 inches.

11. The cutting apparatus of claim 10, wherein the radius of curvature of the inner surface of the cutting assembly is greater than about 9 inches.

12. The cutting apparatus of claim 10, wherein each impeller tube has a longitudinal length of between 5 and 10 inches.

13. The cutting apparatus of claim 10, wherein the cutting assembly comprises four knife assemblies, each knife assembly spaced apart about 90 degrees from one another.

14. The cutting apparatus of claim 13, wherein each knife assembly comprises a blade holding member and a blade, the blade including a corrugated edge with groove and ridge portions on both sides of the blade, the blade forming an angle with a tangent of the inner diameter of the cutting assembly that is less than about 15 degrees.

15. The cutting apparatus of claim 13, wherein the angle formed by the blade and the tangent of the inner diameter of the cutting assembly is about 10 degrees or less.

16. The cutting apparatus of claim 10, wherein the cutting assembly comprises a plurality of knife assemblies and the number of knife assemblies is less than the number of impeller tubes.

17. A method for slicing potatoes comprising:
providing an impeller hub block coupled to a plurality of impeller tubes that radially extend from the impeller hub block;
providing a cutting assembly circumferentially surrounding at least a portion of the plurality of impeller tubes;
providing a plurality of potatoes that have a length greater than about three inches;
feeding the plurality of potatoes into an opening in the impeller hub block;
rotating the impeller hub block about a central vertical axis and causing a first potato and a second potato to be received in one of the impeller tubes in an end-to-end configuration;
cutting an outside portion of the first potato with the first potato being at a first orientation;
rotating the impeller tube about its own longitudinal axis to cause the first potato to be at a second orientation; and
cutting the first potato at the second orientation;
wherein, while the first and second potatoes are in the end-to-end configuration within the one impeller tube, at least one of the first and second potatoes is completely contained within the one impeller tube and the other of the first and second potatoes is at least partially contained in the one impeller tube.

18. The method of claim 17, further comprising:
pre-heating the plurality of potatoes before the potatoes are fed into the opening of the impeller hub block.

19. The method of claim 17, wherein the act of feeding the plurality of potatoes comprises delivering water into the opening in the impeller hub block.
